(19) United States
(12) Patent Application Publication
(10) Pub. No.: US 2024/0176600 A1
(43) Pub. Date: May 30, 2024

(54) Intelligent Adaptation of Source Code for Multi-Purpose Compilation

(71) Applicant: TENCENT AMERICA LLC, Palo Alto, CA (US)

(72) Inventor: Xuelei FAN, Brentwood, CA (US)

(73) Assignee: TENCENT AMERICA LLC, Palo Alto, CA (US)

(21) Appl. No.: 18/060,364

(22) Filed: Nov. 30, 2022

(51) Int. Cl. G06F 8/41

(52) U.S. Cl. CPC G06F 8/41

(57) ABSTRACT

The present disclosure generally relates to computer source code architecture for adaptive compilation, and is particularly directed to methods and systems for intelligently and automatically preprocessing source code for compilation in an adaptive manner for various purposes. The various implementations described in the disclosure below provide examples for such adaptive programing architecture for automatically pre-processing the source code depending on the purpose of a compilation. In particular, one or more of a plurality of types of servicing/supporting modules, functions, or methods in the source code may be adaptively and automatically removed during compilation depending on a type of compilation among a plurality of different types of compilations. In addition, a mechanism is further provided for facilitating intelligent and automatic generation or expansion of servicing or supporting function components in a source code before compilation.

### FIELD OF THE TECHNOLOGY

The present disclosure generally relates to computer source code architecture for adaptive compilation, and is particularly directed to methods and systems for intelligently and automatically preprocessing source code for compilation in an adaptive manner for various purposes.

### BACKGROUND OF THE DISCLOSURE

Executable computer code generally constitutes integral part of various software products or hardware device products. Such executable computer code is usually generated from a set of source code via a compilation process. Besides the various utility modules which are essential to the intended function/operation of the software or hardware products, other servicing/supporting modules, e.g., testing modules or benchmarking modules, are usually also integrated with the set of source code. Traditional compilation of the source code for a production release may unnecessary include these servicing/supporting modules that are only intended for tasks such as testing or benchmarking.

### SUMMARY

The present disclosure generally relates to computer source code architecture for adaptive compilation, and is particularly directed to methods and systems for intelligently and automatically preprocessing source code for compilation in an adaptive manner for various purposes.

In an example implementation, a method for compiling computer source code is disclosed. The method may include receiving a compilation request associated with a set of source code, the set of sourced code comprising a definition of a class, the class comprising a utility function; retrieving the set of source code; automatically identifying a first servicing function demarcated by a first predetermined servicing keyword within the class; the first servicing function being configured to evaluate the utility function; determining a compilation type from the compilation request; automatically altering the first servicing function in the set of source code based on whether the compilation type matches the first predetermined servicing keyword to generate modified set of source code; and compiling the modified set of source code to generate a set of objective code.

In the implementation above, automatically altering the first servicing function in the set of source code based on whether the compilation type matches the first predetermined servicing keyword to generate the modified set of source code may include when the compilation type does not match the first predetermined servicing keyword, automatically removing the first servicing function from the set of source code to generate the modified set of source code.

In any one of the implementations above, the compilation type comprises a production release type and the first predetermined servicing keyword indicates that the first servicing function is for a benchmarking evaluation or a testing of the utility function, and the method comprises removing the first servicing function from the set of source code to generate the modified set of source code.

In any one of the implementations above, automatically altering the first servicing function in the set of source code based on whether the compilation type matches the first predetermined servicing keyword to generate the modified set of source code may further include: when the compilation type matches the first predetermined servicing keyword, automatically expanding the first servicing function to generate an expanded first servicing function and including the expanded first servicing function in the modified set of source code.

In any one of the implementations above, the compilation type may include a benchmarking release type and the first predetermined servicing keyword indicates that the first servicing function is for a benchmarking evaluation of the utility function, and expanding the first servicing function to generate the expanded first servicing function comprises automatically identifying a set of template benchmarking code in a benchmarking code library and automatically adding the set of template benchmarking code to the first servicing function to generate the modified set of source code.

In any one of the implementations above, automatically identifying the set of template benchmarking code in the benchmarking code library may include performing a natural language processing of the first servicing function to identify a benchmarking type; and automatically identifying the set of template benchmarking code from the benchmarking code library according to the benchmarking type.

In any one of the implementations above, automatically expanding the first servicing function to generate the expanded first servicing function and including the expanded first servicing function in the modified set of source code may include automatically determining a classification of the first servicing function; identifying a set of servicing codes according to the classification; and expanding the first servicing function to generate the expanded first servicing function and including the expanded first servicing function in the modified set of source code based on the set of servicing code.

In any one of the implementations above, the method may further include automatically identifying a second servicing function marked by a second predetermined servicing keyword within the class, the second predetermined servicing keyword being different from the first predetermined servicing keyword; and automatically altering the second servicing function in the set of source code based on whether the compilation type matches the second predetermined servicing keyword to generate the modified set of source code.

In any one of the implementations above, the first predetermined servicing keyword indicates that the first servicing function is for a benchmarking evaluation of the utility function and the second predetermined servicing keyword indicates that the second servicing function is for a testing of the utility function.

In any one of the implementations above automatically revising the first servicing function and the second servicing function in the set of source code to generate the modified set of source code may include: when the compilation type matches the first predetermined servicing keyword, automatically generating the modified set of source code by removing the second servicing function and expanding the first servicing function to an expanded first servicing function; when the compilation type matches the second predetermined servicing keyword, automatically generating the modified set of source code by removing the first servicing function and retaining the second servicing function in the set of source code; and when the compilation type indicates a production release type, automatically generating the modified set of source code by removing both the first servicing function and the second servicing function from the set of source code.

According to some other aspects of this disclosure, an electronic device is disclosed. The electronic device may include a memory for storing computer instructions and a processor for executing the computer instructions to implement any one of the methods above.

According to yet some other aspects of this disclosure, a non-transitory computer-readable medium is disclosed. The non-transitory computer-readable medium may be configured to store computer instructions, the computer instructions, when executed by a processor of an electronic device, being configured to cause the electronic device to implemented any one of the methods above.

The above and other aspects and their implementations are described in greater detail in the drawings, the descriptions, and the claims below.

### BRIEF DESCRIPTION OF THE DRAWINGS

FIG. 1 shows a flow diagram of an embodiment disclosed in the present disclosure.

FIG. 2 shows a schematic diagram of an electronic device disclosed in the present disclosure.

### DETAILED DESCRIPTION OF THE DISCLOSURE

The invention will now be described in detail hereinafter with reference to the accompanied drawings, which form a part of the present invention, and which show, by way of illustration, specific examples of embodiments. Please note that the invention may, however, be embodied in a variety of different forms and, therefore, the covered or claimed subject matter is intended to be construed as not being limited to any of the embodiments to be set forth below. Please also note that the invention may be embodied as methods, devices, components, or systems. Accordingly, embodiments of the invention may, for example, take the form of hardware, software, firmware or any combination thereof.

Throughout the specification and claims, terms may have nuanced meanings suggested or implied in context beyond an explicitly stated meaning. The phrase “in one embodiment” or “in some embodiments” as used herein does not necessarily refer to the same embodiment and the phrase “in another embodiment” or “in other embodiments” as used herein does not necessarily refer to a different embodiment. Likewise, the phrase “in one implementation” or “in some implementations” as used herein does not necessarily refer to the same implementation and the phrase “in another implementation” or “in other implementations” as used herein does not necessarily refer to a different implementation. It is intended, for example, that claimed subject matter includes combinations of exemplary embodiments/implementations in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” or “at least one” as used herein, depending at least in part upon context, may be used to describe any feature, structure, or characteristic in a singular sense or may be used to describe combinations of features, structures or characteristics in a plural sense. Similarly, terms, such as “a”, “an”, or “the”, again, may be understood to convey a singular usage or to convey a plural usage, depending at least in part upon context. In addition, the term “based on” or “determined by” may be understood as not necessarily intended to convey an exclusive set of factors and may, instead, allow for existence of additional factors not necessarily expressly described, again, depending at least in part on context.

By way of introduction, executable computer code generally constitutes integral part of various software products or hardware device products. Such executable computer code is usually generated from a set of source code via a compilation process. Besides the various utility modules which are essential to the intended functioning and operation of the software or hardware products, other servicing/supporting modules are usually also integrated with the set of source code during the programing stage. The servicing modules may include various callable serving/supporting methods of functions. The term “method” and “function” are used interchangeably in this disclosure.

For example, in a traditional programing language based on an object-oriented programing architecture, various methods or functions may be defined and included in the source code for purposes of assisting evaluation of other utility functions and methods. These types of servicing methods/functions play a supporting role in the sense that they are used for servicing/supporting tasks such as testing or benchmarking other utility functions and methods. These servicing/supporting methods/functions thus must be included during compilation process for servicing releases (e.g., testing and/or benchmarking releases). The term “servicing” is used interchangeably with the term “evaluation”. As such, the term “evaluation” takes a broader scope than indicated in its literal sense and covers any other type of servicing methods/functions as opposed to the utility functions and methods. Testing and benchmarking of other utility methods and functions are merely examples for servicing or evaluation tasks. The term “utility” is used to refer to operations intended by the software or hardware products. The various servicing methods/functions may be alternatively referred to as “product-detached” methods/functions, because these methods/functions are not needed in and can be detached from a product release.

While these servicing/supporting methods/functions are needed for service or evaluation releases, they need not be included for the operation of the released software or hardware in a production environment. However, during a compilation process for a production release, because these servicing and evaluation methods or functions are part of the source code and are considered as potentially callable, they would nevertheless be compiled into, for example, objective codes, and ready for linking during execution of the compiled production release. The compiled code of these servicing or evaluation methods or functions may thus unnecessarily become a part of the final product, giving rise to a waste of resources.

It may thus be desirable to design a programing architecture in which different parts of the source code may be selectively included during compilation depending of the purpose of a release or build. For example, portions of the source code only pertaining to testing may be stripped in compilation for production releases or for benchmarking releases. For another example, portions of the source code only pertaining to benchmarking may be stripped in compilation for production releases or for testing releases. Likewise, portions of the source code only pertaining to testing or benchmarking may both be stripped in compilation for production releases. The various implementations described in the disclosure below provide examples for such adaptive programing architecture for automatically pre-processing the source code depending on the purpose of the release before compilation. In particular, one or more of a plurality of types of servicing/supporting modules, functions, or methods in the source code may be adaptively and automatically removed during compilation depending on a type of release among a plurality of different types of release (e.g., production release, testing release, benchmarking release, and the like). The disclosed implementations, while being generally pertinent to computer technology itself and only existing in the technical realm of computers, help improve computing technologies by reducing resource consumption (e.g., memory consumption) at the programing architecture level.

In addition, the various example implementations below further provide a mechanism for facilitating intelligent and automatic generation or expansion of servicing or supporting function components. Such a mechanism, for example, may utilize natural language processing and other techniques to extract information from existing lines of servicing or supporting code and to expand the existing servicing or supporting code to include code for additional servicing/supporting components. For example, for benchmarking, the supporting functions in the source code may be allowed to be presented as pseudo codes, natural language descriptions, or the like. The mechanism disclosed below may process such source code, identify the servicing/supporting functions, intelligently and automatically extract semantics from the pseudo code or natural language descriptions to generate an expanded set of compliable servicing/supporting codes. The expanded codes together with the rest of the source code may then be compiled for the intended servicing/supporting release. Such a mechanism is suited particular for benchmarking, where a library of benchmarking functions may be specified and extracted for an expansion of a set of benchmarking functions in the source code based on analytics of the existing lines of benchmarking codes in the source code.

In some example implementations, a set of source code may be assembled from a plurality of workspaces. The servicing or supporting source codes and the utility source codes may be separately constructed in different workspaces. In such a manner, compilation of the source code for a particular release may be confined to one or more particular workspaces and source code in other workspaces may be excluded in the compilation. For example, the workspaces for a set of source code may include a testing workspace, a benchmarking workspace, and a production workspace. A compilation for product release, for example, may be confined to the production workspace. The different workspaces may be implemented as different classes or coding packages.

However, in object-oriented programming language, because of the encapsulation principle, separated classes or methods cannot effectively access restricted components of a target programing unit. For example, private methods of a class are not accessible from outside of this class. Encapsulation is fundamental to object-oriented programing and it limits the services that a supporting method separated in workspace from its target utility method or function can provide. For example, testing or benchmarking from one class of a utility function in another class may be limited, thereby reducing the testing coverage.

For example, a private utility class may be included in a package “com.example” below, and the private utility class “AppClass” may include a utility function “mux( )”: Such a limitation of inter class accessibility is illustrated in the example code below.

```
package com.example;
private class AppClass {
  private static int mux(int ctl, int x, int y) {
    return y \hat{ } (−ctl & (x \hat{ } y));
  }
}
```

Such code may be placed in a src directory. As shown above, the “AppClass” class and “mux( )” method therein are private and thus cannot be tested directly in a third code workspace, or from outside of the private utility class above.

If the utility class and the method is designated instead as public, then the test code for the “mux( )” referred to in a “main” method in a separate class containing a “TestAppClass” class could then be placed in a test workspace, as shown below:

```
import com.example.AppClass;
public class TestAppClass {
  public static void main(String[ ] args) {
    if (AppClass.mux(1, 0xFF, 0xAA) != 0xFF) {
      throw new RuntimeException( );
    }
  }
}
```

However, besides requiring the utility and servicing classes being public, the separation of the locations of servicing source code and target utility source code being tested could add considerable complexity to the maintenance of the source code. A developer may have to keep track of and look for where the service source code is located. The location may be not as easy to identify when the source code structure becomes a lot more complex than the example above.

In some example implementations, the servicing/supporting source code and the target utility source code may be co-located. For example, they may belong to a same workspace. Specifically, they may be defined in a same class. In order to provide an automatic capability for adaptively excluding various servicing/supporting source code in compiling for releases of different purposes, the various servicing/supporting methods/functions may be tagged or demarcated in the source code with predefined keywords. In such a manner, a particular type of servicing/supporting functions or methods in the source code may then be automatically identified via keyword recognition and adaptively removed for a compilation of a particular type of release or build.

This example approach provides better servicing or supporting coverage by the servicing/supporting source codes because they are collocated with the target utility methods/functions in the same workspace. There would be no need of having to work-around any encapsulation problem. In the meanwhile, this approach provides removal of unnecessary serving/supporting source code in a compiled version that would otherwise occupy resources that may not be used anyway. For example, servicing/supporting methods or functions for tasks such as testing or benchmarking of target utility methods or functions would be automatically recognized and removed for a production release thereby saving resource occupation of the production build. For another example, benchmarking source code may be automatically removed for testing build. Likewise, testing source code may be automatically recognized and removed for benchmarking build. Further, because the servicing/supporting source code is co-located with the target utility source code in, for example, a same workspace, the programing process and maintenance of the source code become more efficient and less error-prone for developers. Automation of the servicing/supporting tasks also becomes easier to design and provision.

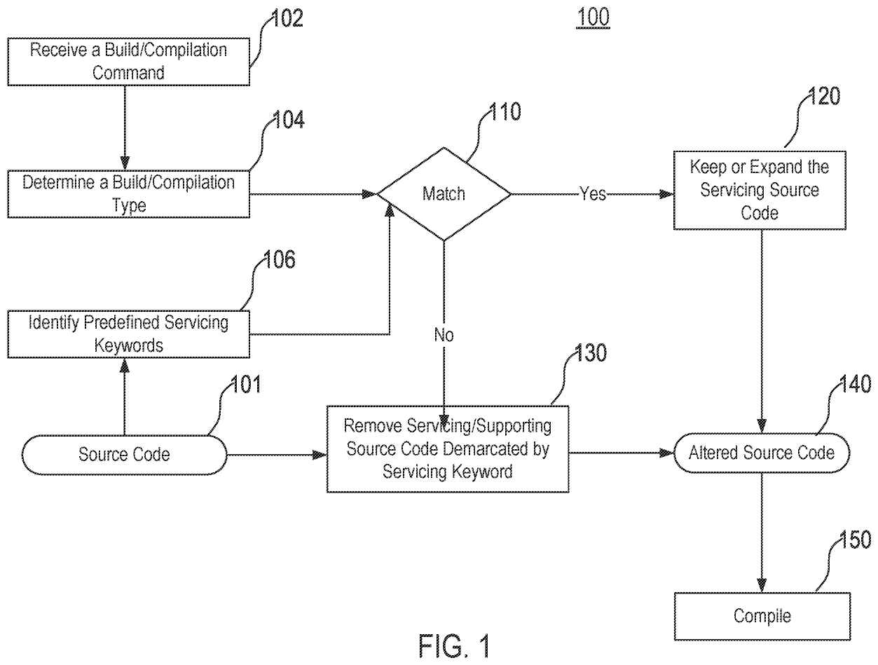

FIG. 1 illustrates an example flow chart 100 for the adaptive programing architecture and source code compilation mechanism described above. As shown in Step 102 of FIG. 1, a build/compilation command may be received with respect to a set of source code 101. At step 104, a release/compilation/build type may be determined. The release/compilation/build type may indicate the purpose for the compilation. For example, the compilation may be requested for an evaluation service of one or more utility methods/functions of the source code. The requested evaluation service may include one or more of testing, benchmarking, and the like, corresponding to one of a testing release/compilation/build type, a benchmarking release/compilation/build type, or a testing and benchmarking release/compilation/build. In step 106, one or more predefined servicing keywords may be further recognized or identified from the source code 101. In step 110, each of these recognized servicing keywords may be compared with the compilation type. If there is a match, then the corresponding servicing methods/functions or portions in the source code 101 demarcated by the matching predefined servicing keyword may be retained or expanded in the set of source code 101 to generated a set of altered source code 140. Otherwise, if a recognized servicing keywork does not match the compilation type at step 110, then the corresponding servicing methods/functions or portions in the source code 101 demarcated by the non-matching predefined servicing keyword may be filtered/removed from the source code 101 to generate the altered source code 140. At step 150, the altered source code 140 may then be compiled.

The terms “match” and “matching” above are used in a broad manner, covering exact matches, as well as approximate matches. For example, the compilation requests may be attributed or classified in a predefined set of types, with the types being labeled identically to the predefined set of servicing keywords. In some other implementations, there may be fewer types of compilation and each of the compilation types may be considered as matching one or more servicing keywords. For example, there may be two compilation types: production release type and servicing release type, and both a “test-only” servicing keyword and “benchmark-only” keyword may be considered as matching the servicing release type.

In a specific example implementation of the programing architecture above, at least a set of serving keywords may be predefined, e.g., “test-only”, “benchmark-only”, “test-and-benchmark, and the like. During source code development, a class may be defined in the source code. The class may be used as a basis to create objects in the utility class for operation of the corresponding product. The class may include a set of utility functions and methods callable by objects of the class. The class may further include a set of servicing methods/function. One or more these servicing methods/functions may be demarcated by one or more of the predefined servicing keywords, such as “test-only”, “benchmark-only”, “test-and-benchmark”, and the like. Because the servicing methods/functions are placed in the same class as the utility methods/functions, the class type needs not be limited to a particular accessibility level. As such, the class may be public, private, or any other types of classes.

In an example, for a product release, in the source code compiling stage of the mechanism described in FIG. 1, the servicing methods/functions demarcated by the servicing keywords above would be ignored or removed from the source code before compiling. These functions are thus not wrapped into the product release.

In another example, for specific supporting build such as a testing build, in the source code compiling stage of the mechanism described in FIG. 1, the servicing methods/functions demarcated with the keyword “benchmark-only” would be ignored or removed from the source code before compiling.

In another example, for specific supporting build such as a benchmarking build, in the source code compiling stage of the mechanism described in FIG. 1, the servicing methods/functions demarcated with the keyword “test-only” would be ignored or removed from the source code before compiling.

In yet another example, for specific supporting build such as a testing and benchmarking build, in the source code compiling stage of the mechanism described in FIG. 1, none of the servicing methods/functions demarcated with the keyword “test-only” or “benchmark-only” would be ignored or removed from the source code before compiling.

Example source code developed based on the adaptive programing architecture and compilation mechanism above is shown below for an example private class “AppClass” having an utility function mux( ), a servicing function for testing, textMux( ), and a servicing function for benchmarking, bechMux( ):

```
package com.example;
private class AppClass {
// product-bind method
  static int mux(int ctl, int x, int y) {
    return y \hat{ } (−ctl & (x \hat{ } y));
  }
  // product-detached method for testing
  test-only void testMux( ) {
    if (mux(1, 0xFF, 0xAA) != 0xFF) {
      throw new RuntimeException( );
    }
  }
  // product-detached method for benchmark-only
  benchmark-only void benchMux( ) {
    mux(1, 0xFF, 0xAA);
  }
}
```

For a product release compilation, after removing the servicing methods and functions, the portion of the code above that may be actually compiled would be:

```
package com.example;
private class AppClass {
// product-bind method
  static int mux(int ctl, int x, int y) {
    return y \hat{ } (−ctl & (x \hat{ } y));
  }
}
```

For a testing build, the compiler could ignore the supporting method that is not for testing (e.g., removing the benchmarking functions), and treat the source code as the following:

```
package com.example;
private class AppClass {
// product-bind method
  static int mux(int ctl, int x, int y) {
    return y \hat{ } (−ctl & (x \hat{ } y));
  }
  // product-detached method for testing
  test-only void testMux( ) {
    if (mux(1, 0xFF, 0xAA) != 0xFF) {
      throw new RuntimeException( );
    }
  }
}
```

In some example implementations, the compiler may further automatically and intelligently extend or expand its servicing/supporting capability. For example, the compiler may check if all product-bind utility methods/functions are testing-covered and issue a warning or fail the compilation if a specific product-bind method/function is not testing-covered. In the following example, the compiler could warn or fail as there is no testing coverage for a ‘not( )’ method.

```
package com.example;
private class AppClass {
// product-bind method
  static int mux(int ctl, int x, int y) {
    return y \hat{ } (−ctl & (x \hat{ } y));
  }
  // product-bind method
  static int not(int ctl) {
    return ctl \hat{ } 1;
  }
  // product-detached method for testing
    test-only void testMux( ) {
      if (mux(1, 0xFF, 0xAA) != 0xFF) {
        throw new RuntimeException( );
      }
    }
  }
```

For a benchmark build in the example above, the compiler would ignore/remove the supporting functions and methods that are not for benchmarking before compiling, and treat the source code as the following:

```
package com.example;
private class AppClass {
// product-bind method
  static int mux(int ctl, int x, int y) {
    return y \hat{ } (−ctl & (x \hat{ } y));
  }
  // product-detached method for benchmark-only
  benchmark-only void benchMux( ) {
    mux(1, 0xFF, 0xAA);
  }
}
```

In some example implementations, the compiler may further automatically extend the benchmarking methods/functions for better support. For example, the compiler may automatically and intelligently generate additional benchmarking code based on and on top of the existing benchmarking methods/functions in the source code. In the example above, the benchMux( ) method in the original source code may not be a full set of benchmarking source code. The compiler may automatically extend the benchMux( ) method and generate a more comprehensive set of benchmarking source code. The following automatically expanded benchmarking code is merely an example for what a Java compiler could do to expand the simple existing benchMux( ) method into a full set of benchmarking code. In the example, the Java compiler could use existing Java Microbenchmark Harness (JMH) toolkit from a benchmarking library and automatically generate a more comprehensive set of benchmarking testing code for benchMux( ) method. For example, an automatically extended source code for benchmarking purpose may be:

```
package com.example;
import org.openjdk.jmh.annotations.*;
import org.openjdk.jmh.runner.*;
import org.openjdk.jmh.runner.options.*;
import java.util.concurrent.TimeUnit;
@BenchmarkMode(Mode.Throughput)
@OutputTimeUnit(TimeUnit.MILLISECONDS)
@State(Scope.Thread)
@Fork(3)
@Warmup(iterations = 5)
@Measurement(iterations = 5)
public class AppClass {
// product-bind method
  static int mux(int ctl, int x, int y) {
    return y \hat{ } (−ctl & (x \hat{ } y));
  }
  public static void main(String[ ] args) throws RunnerException {
    Options options = new OptionsBuilder( )
      .include(AppClass.class.getSimpleName( ))
      .forks(3)
      .warmupIterations(5)
      .measurementIterations(5)
      .build( );
    new Runner(options).run( );
  }
  // product-detached method for benchmark-only
  @Benchmark
  public void benchMux( ) {
    mux(1, 0xFF, 0xAA);
  }
```

In some other example implementations, a servicing/supporting function may be allowed to be written in pseudo code, or even in natural language, without being restricted to normal programing syntax. The compiler, once recognizing a servicing keyword, may then automatically performs natural language processing to determine a type and a scope of the service, and then automatically generates a set of servicing code from a servicing code library. The natural language processing may be based on pre-trained natural language models for semantic recognition.

In the examples above, the demarcation of the service methods/functions are implemented by placing the corresponding servicing keywords at the header of the servicing methods/functions for easier syntactic recognition. Other manners in which the servicing keywords are included are contemplated and are not so limited.

In the embodiments and implementation of this disclosure, any steps and/or operations may be combined or arranged in any amount or order, as desired. Two or more of the steps and/or operations may be performed in parallel. Embodiments and implementations in the disclosure may be used separately or combined in any order.

Thus, the adaptive programing architecture and compiling mechanism above can be used to effectively organize software utility source code and servicing/supporting code in a programming language and provide at least the following improvements:

Servicing/supporting methods/functions that are not need for product release are not compiled into the product build, thereby saving resource occupation in product release.

Only servicing/supporting methods/functions that are needed for a particular release are compiled into the release of the special purpose, thereby providing servicing/supporting capability such as testing or benchmarking of utility methods/functions.

The various servicing/supporting methods/functions can be located at the same place (or workspace or class) as the target utility methods/functions and are thus less impacted by encapsulation limits in object-oriented programming languages.

The various servicing/supporting methods/functions can be located at the same place (or workspace or class) as the target utility methods/functions, and thus help simplify the development and maintenance of both target code and servicing/supporting code, thereby improving the qualities of the resulting software.

Each servicing/supporting method/function may be designed for a specific purpose. A program language or compiler could automatically make further improvement of the method/function for the specific purpose. For example, for a benchmarking method, the compiler may automatically include additional benchmarking code. In such a manner, the developers only need to focus on the benchmarking logic, and shift actual coding for common benchmarking tasks such as warm-up, threading, and iterations to the compiler.

Such a programming language could define new features for other benefits from the various servicing/supporting methods/functions. For example, a compiler could automatically check the testing result before the final product release.

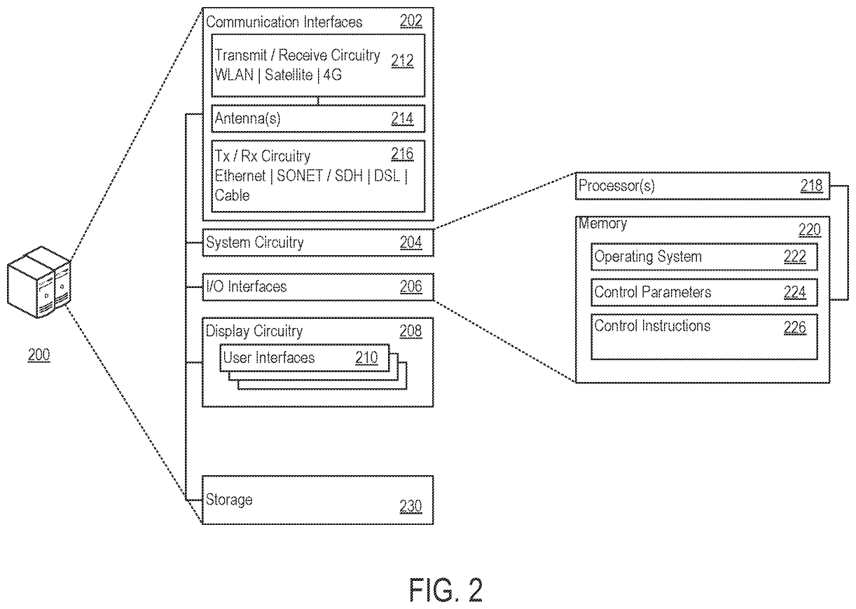

For example, FIG. 2 shows an example of an electronic device 200 to implement one or more method described in the present disclosure. In one implementation, the electronic device 200 may be at least one of a computer, a server, a laptop, or a mobile device. In another implementation, the electronic device 200 may be a set of electronic devices comprising at least one of one or more computing server, one or more data server, one or more network server, one or more terminal, one or more laptop, and/or one or more mobile device.

The electronic device 200 may include communication interfaces 202, a system circuitry 204, an input/output interfaces (I/O) 206, a display circuitry 208, and a storage 209. The display circuitry may include a user interface 210. The system circuitry 204 may include any combination of hardware, software, firmware, or other logic/circuitry. The system circuitry 204 may be implemented, for example, with one or more systems on a chip (SoC), application specific integrated circuits (ASIC), discrete analog and digital circuits, and other circuitry. The system circuitry 204 may be a part of the implementation of any desired functionality in the electronic device 200. In that regard, the system circuitry 204 may include logic that facilitates, as examples, decoding and playing music and video, e.g., MP3, MP4, MPEG, AVI, FLAC, AC3, or WAV decoding and playback; running applications; accepting user inputs; saving and retrieving application data; establishing, maintaining, and terminating cellular phone calls or data connections for, as one example, internet connectivity; establishing, maintaining, and terminating wireless network connections, Bluetooth connections, or other connections; and displaying relevant information on the user interface 210. The user interface 210 and the inputs/output (I/O) interfaces 206 may include a graphical user interface, touch sensitive display, haptic feedback or other haptic output, voice or facial recognition inputs, buttons, switches, speakers and other user interface elements. Additional examples of the I/O interfaces 206 may include microphones, video and still image cameras, temperature sensors, vibration sensors, rotation and orientation sensors, headset and microphone input/output jacks, Universal Serial Bus (USB) connectors, memory card slots, radiation sensors (e.g., IR sensors), and other types of inputs.

Referring to FIG. 2, the communication interfaces 202 may include wireless transmitters and receivers (“transceivers”) and any antennas used by the transmitting and receiving circuitry of the transceivers. The communication interfaces 202 may also include wireline transceivers, which may provide physical layer interfaces for any of a wide range of communication protocols, such as any type of Ethernet, data over cable service interface specification (DOCSIS), digital subscriber line (DSL), Synchronous Optical Network (SONET), or other protocol. The communication interfaces 202 may include a Radio Frequency (RF) transmit (Tx) and receive (Rx) circuitry 216 which handles transmission and reception of signals through one or more antennas 214. The communication interface 202 may include one or more transceivers. The transceivers may be wireless transceivers that include modulation/demodulation circuitry, digital to analog converters (DACs), shaping tables, analog to digital converters (ADCs), filters, waveform shapers, filters, pre-amplifiers, power amplifiers and/or other logic for transmitting and receiving through one or more antennas, or (for some devices) through a physical (e.g., wireline) medium. The transmitted and received signals may adhere to any of a diverse array of formats, protocols, modulations (e.g., QPSK, 16-QAM, 64-QAM, or 256-QAM), frequency channels, bit rates, and encodings. As one specific example, the communication interfaces 202 may include transceivers that support transmission and reception under the 2G, 3G, BT, WiFi, Universal Mobile Telecommunications System (UMTS), High Speed Packet Access (HSPA)+, 4G/Long Term Evolution (LTE), and 5G standards. The techniques described below, however, are applicable to other wireless communications technologies whether arising from the 3rd Generation Partnership Project (3GPP), GSM Association, 3GPP2, IEEE, or other partnerships or standards bodies.

The system circuitry 204 may include hardware, software, firmware, or other circuitry in any combination. The system circuitry 204 may be implemented, for example, with one or more systems on a chip (SoC), application specific integrated circuits (ASIC), microprocessors, discrete analog and digital circuits, and other circuitry. For example, referring to FIG. 2, the system circuitry 204 may include one or more processors 221 and memories 222. The memory 222 stores, for example, an operating system 224, instructions 226, and parameters 228. The processor 221 is configured to execute the instructions 226 to carry out desired functionality for the electronic device 200. The parameters 228 may provide and specify configuration and operating options for the instructions 226. The memory 222 may also store any BT, WiFi, 3G, 4G, 5G or other data that the electronic device 200 will send, or has received, through the communication interfaces 202. In various implementations, a system power for the electronic device 200 may be supplied by a power storage device, such as a battery or a transformer.

The storage 209 may be used to store various initial, intermediate, or final data. In one implementation, the storage 209 may be integral with a database server. The storage 209 may be centralized or distributed, and may be local or remote to the electronic device 200. For example, the storage 209 may be hosted remotely by a cloud computing service provider.

While the particular invention has been described with reference to illustrative embodiments, this description is not meant to be limiting. Various modifications of the illustrative embodiments and additional embodiments of the invention will be apparent to one of ordinary skill in the art from this description. Those skilled in the art will readily recognize that these and various other modifications can be made to the exemplary embodiments, illustrated and described herein, without departing from the spirit and scope of the present invention. It is therefore contemplated that the appended claims will cover any such modifications and alternate embodiments. Certain proportions within the illustrations may be exaggerated, while other proportions may be minimized. Accordingly, the disclosure and the figures are to be regarded as illustrative rather than restrictive.

What is claimed is:

1. A method for processing computer source code, the method comprising:
receiving a compilation request associated with a set of source code, the set of sourced code comprising a definition of a class, the class comprising a utility function;
retrieving the set of source code;
automatically identifying a first servicing function demarcated by a first predetermined servicing keyword within the class; the first servicing function being configured to evaluate the utility function;
determining a compilation type from the compilation request;
automatically altering the first servicing function in the set of source code based on whether the compilation type matches the first predetermined servicing keyword to generate modified set of source code; and
compiling the modified set of source code to generate a set of objective code.

2. The method of claim 1, wherein automatically altering the first servicing function in the set of source code based on whether the compilation type matches the first predetermined servicing keyword to generate the modified set of source code comprises:
when the compilation type does not match the first predetermined servicing keyword, automatically removing the first servicing function from the set of source code to generate the modified set of source code.

3. The method of claim 2, wherein the compilation type comprises a production release type and the first predetermined servicing keyword indicates that the first servicing function is for a benchmarking evaluation or a testing of the utility function, and the method comprises removing the first servicing function from the set of source code to generate the modified set of source code.

4. The method of claim 2, wherein automatically altering the first servicing function in the set of source code based on whether the compilation type matches the first predetermined servicing keyword to generate the modified set of source code further comprises:
when the compilation type matches the first predetermined servicing keyword, automatically expanding the first servicing function to generate an expanded first servicing function and including the expanded first servicing function in the modified set of source code.

5. The method of claim 4, wherein the compilation type comprises a benchmarking release type and the first predetermined servicing keyword indicates that the first servicing function is for a benchmarking evaluation of the utility function, and wherein expanding the first servicing function to generate the expanded first servicing function comprises automatically identifying a set of template benchmarking code in a benchmarking code library and automatically adding the set of template benchmarking code to the first servicing function to generate the modified set of source code.

6. The method of claim 5, wherein automatically identifying the set of template benchmarking code in the benchmarking code library comprises:
performing a natural language processing of the first servicing function to identify a benchmarking type; and
automatically identifying the set of template benchmarking code from the benchmarking code library according to the benchmarking type.

7. The method of claim 4, wherein automatically expanding the first servicing function to generate the expanded first servicing function and including the expanded first servicing function in the modified set of source code comprises:
automatically determining a classification of the first servicing function;
identifying a set of servicing codes according to the classification; and
expanding the first servicing function to generate the expanded first servicing function and including the expanded first servicing function in the modified set of source code based on the set of servicing code.

8. The method of claim 1, further comprising:
automatically identifying a second servicing function marked by a second predetermined servicing keyword within the class, the second predetermined servicing keyword being different from the first predetermined servicing keyword; and
automatically altering the second servicing function in the set of source code based on whether the compilation type matches the second predetermined servicing keyword to generate the modified set of source code.

9. The method of claim 8, wherein the first predetermined servicing keyword indicates that the first servicing function is for a benchmarking evaluation of the utility function and the second predetermined servicing keyword indicates that the second servicing function is for a testing of the utility function.

10. The method of claim 9, wherein automatically revising the first servicing function and the second servicing function in the set of source code to generate the modified set of source code comprises:
when the compilation type matches the first predetermined servicing keyword, automatically generating the modified set of source code by removing the second servicing function and expanding the first servicing function to an expanded first servicing function;
when the compilation type matches the second predetermined servicing keyword, automatically generating the modified set of source code by removing the first servicing function and retaining the second servicing function in the set of source code; and
when the compilation type indicates a production release type, automatically generating the modified set of source code by removing both the first servicing function and the second servicing function from the set of source code.

11. A device for processing computer source code, comprising a memory for storing a compiler program, and a processor configured to executed the compiler program to:
receiving a compilation request associated with a set of source code, the set of sourced code comprising a definition of a class, the class comprising a utility function;
retrieve the set of source code;
automatically a first servicing function demarcated by a first predetermined servicing keyword within the class; the first servicing function being configured to evaluate the utility function;
determine a compilation type from the compilation request;
automatically alter the first servicing function in the set of source code based on whether the compilation type matches the first predetermined servicing keyword to generate modified set of source code; and
compile the modified set of source code to generate a set of objective code.

12. The device of claim 11, wherein to automatically alter the first servicing function in the set of source code based on whether the compilation type matches the first predetermined servicing keyword to generate the modified set of source code comprises:
when the compilation type does not match the first predetermined servicing keyword, automatically remove the first servicing function from the set of source code to generate the modified set of source code.

13. The device of claim 12, wherein the compilation type comprises a production release type and the first predetermined servicing keyword indicates that the first servicing function is for a benchmarking evaluation or a testing of the utility function, and the processor is configured to execute the compiler program to remove the first servicing function from the set of source code to generate the modified set of source code.

14. The device of claim 12, wherein to automatically alter the first servicing function in the set of source code based on whether the compilation type matches the first predetermined servicing keyword to generate the modified set of source code further comprises:
when the compilation type matches the first predetermined servicing keyword, automatically expand the first servicing function to generate an expanded first servicing function and including the expanded first servicing function in the modified set of source code.

15. The device of claim 14, wherein the compilation type comprises a benchmarking release type and the first predetermined servicing keyword indicates that the first servicing function is for a benchmarking evaluation of the utility function, and wherein to expand the first servicing function to generate the expanded first servicing function comprise automatically identify a set of template benchmarking code in a benchmarking code library and automatically adding the set of template benchmarking code to the first servicing function to generate the modified set of source code.

16. The device of claim 15, wherein to automatically identify the set of template benchmarking code in the benchmarking code library comprises:
perform a natural language processing of the first servicing function to identify a benchmarking type; and
automatically identify the set of template benchmarking code from the benchmarking code library according to the benchmarking type.

17. The device of claim 14, wherein to automatically expand the first servicing function to generate the expanded first servicing function and including the expanded first servicing function in the modified set of source code comprises:
automatically determine a classification of the first servicing function;
identify a set of servicing codes according to the classification; and
expand the first servicing function to generate the expanded first servicing function and including the expanded first servicing function in the modified set of source code based on the set of servicing code.

18. The device of claim 11, the processor is further configured to execute the compiler program to:
automatically identify a second servicing function marked by a second predetermined servicing keyword within the class, the second predetermined servicing keyword being different from the first predetermined servicing keyword; and
automatically alter the second servicing function in the set of source code based on whether the compilation type matches the second predetermined servicing keyword to generate the modified set of source code.

19. The device of claim 18, wherein the first predetermined servicing keyword indicates that the first servicing function is for a benchmarking evaluation of the utility function and the second predetermined servicing keyword indicates that the second servicing function is for a testing of the utility function.

20. The device of claim 19, wherein to automatically revise the first servicing function and the second servicing function in the set of source code to generate the modified set of source code comprises:
when the compilation type matches the first predetermined servicing keyword, automatically generate the modified set of source code by removing the second servicing function and expanding the first servicing function to an expanded first servicing function;
when the compilation type matches the second predetermined servicing keyword, automatically generate the modified set of source code by removing the first servicing function and retaining the second servicing function in the set of source code; and
when the compilation type indicates a production release type, automatically generate the modified set of source code by removing both the first servicing function and the second servicing function from the set of source code.
